(19) United States
(12) Patent Application Publication
(10) Pub. No.: US 2011/0183831 A1
(43) Pub. Date: Jul. 28, 2011

(54) GLASS ARTICLE WITH IMPROVED CHEMICAL RESISTANCE

(75) Inventors: Fabian Mariage, Jumet (BE); Pierre Boulanger, Jumet (BE); Dominique Coster, Jumet (BE); Marc Van Den Neste, Jumet (BE); Christine Deneil, Jumet (BE)

(73) Assignee: AGC Glass Europe, Bruxelles (Watermael-Boitsfort) (BE)

(21) Appl. No.: 13/122,638

(22) PCT Filed: Oct. 19, 2009
(86) PCT No.: PCT/EP2009/063651

§ 371 Date: Apr. 5, 2011

(30) Foreign Application Priority Data
Oct. 20, 2008 (EP) 08167008.5

(51) Int. Cl. C03C 14/00; B82Y 30/00

(52) U.S. Cl. 501/32; 977/773

(57) ABSTRACT

It is possible to reduce the time required for a path recalculation and a path switching upon occurrence of a failure. A path generation unit of a transport control server (TCS) S-1 generates normal path information in accordance with information relating to topology of a network to be established and resource information. Moreover, the path generation unit generates in advance backup path information to be used upon occurrence of a failure in accordance with the prediction topology information and the prediction resource information which have been modified in accordance with a predicted failure position. The path generation unit stores the generated prediction path information in a data storage unit. The TCS (S-1) has a path information report unit which reports the generated normal path information to a node N. The TCS (S-1) also has a failure information acquisition unit which detects occurrence of a failure. When the failure information acquisition unit detects an occurrence of a failure, the path information report unit reports the backup path information stored in the data storage unit to the node N.

The present invention relates to a glass article having a higher and improved chemical resistance compared to known glass articles.

It is known that glass can corrode under the influence of unfavourable environmental conditions, in particular in aqueous media with alkaline pH, if it has not been subjected to a protective treatment. When the glass is soda-lime glass the alkaline metal cations such as Na⁺, and to a lesser degree K⁺, when close to the surface of the glass, can leave this and dissolve in the surrounding medium, e.g. in the presence of humidity and surface water. Various methods have been proposed to limit this phenomenon such as e.g. a treatment to deplete these ions close to the surface of the glass article. This method consists of treating the surface of the glass with a chemical agent, e.g. SO₂, that is suitable for eliminating or greatly reducing the sodium and/or potassium content in a thin zone close to this surface.

However, the effectiveness of this technique is restricted in time as a result of the slow diffusion of the Na⁺ and K⁺ ions coming from the core of the glass article caused by the concentration gradient created by the depletion treatment of these ions close to the surface.

The invention remedies these disadvantages by providing a glass with improved chemical resistance that is stable in various environmental conditions, possibly in alkaline aqueous media, and that is durable over extended periods of use. Furthermore, this glass with improved chemical resistance can no longer be subjected to a treatment for depleting Na⁺ and/or K⁺ ions or conversely it can undergo a complementary treatment for depleting Na⁺ and/or K⁺ ions that would further increase its chemical resistance.

On this basis, the invention relates to a glass article such as defined in claim 1.

The dependent claims define other possible embodiments of the invention, some of which are preferred.

The present invention shall be described in more detail and in a non-restrictive manner with reference to the attached figures (not to scale).

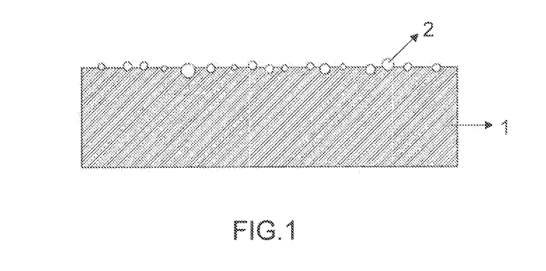

FIG. 1 shows a section of a glass article according to a particular embodiment of the invention.

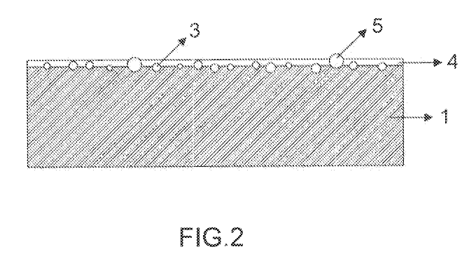

FIG. 2 shows a section of a glass article according to another particular embodiment of the invention.

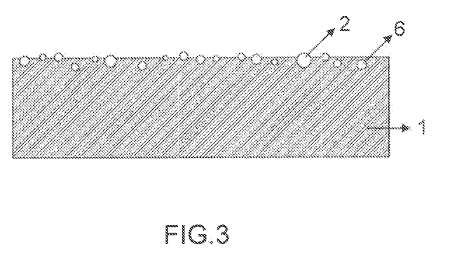

FIG. 3 shows a section of a glass article according to a further particular embodiment of the invention.

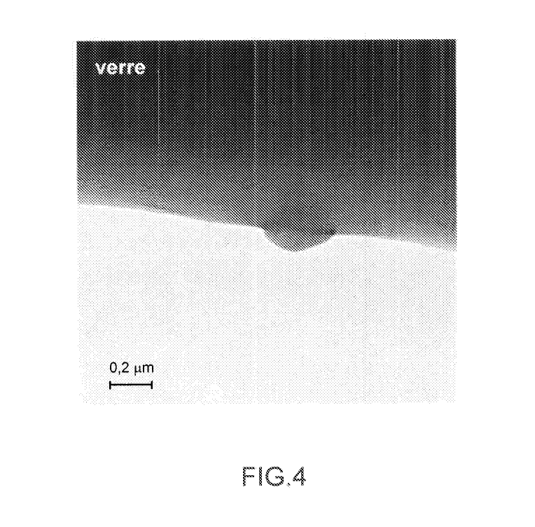

FIG. 4 shows a transmission electron microscope image of a glass article according to the invention.

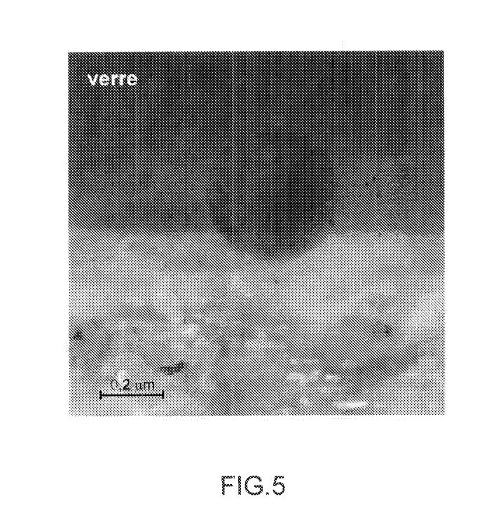

FIG. 5 shows another transmission electron microscope image of a glass article according to the invention.

The glass article according to the invention is made from an inorganic glass that can belong to various categories. The inorganic glass can thus be a soda-lime glass, a boron glass, a lead glass, a glass containing one or more additives distributed homogeneously through its bulk such as, for example, at least one inorganic dye, an oxidising compound, a viscosity regulating agent and/or a melting aid. The inorganic glass can also have undergone a thermal toughening process intended to improve its surface hardness. Preferably, the glass article according to the invention is made from a clear or solidly coloured soda-lime glass. The expression “soda-lime glass” is used in its broad sense here and relates to any glass that contains the following base components (expressed in percentages of the total weight of glass):

| | |
|---|---|
| SiO₂ | 60 to 75% |
| Na₂O | 10 to 20% |
| CaO | 0 to 16% |
| K₂O | 0 to 10% |
| MgO | 0 to 10% |
| Al₂O₃ | 0 to 5% |
| BaO | 0 to 2% |
| BaO + CaO + MgO | 10 to 20% |
| K₂O + Na₂O | 10 to 20% |

It also relates to any glass containing the above base components that can additionally contain one or more additives.

In general, it is also preferred that the glass article has not been covered by any layer before the treatment of the present invention, at least on the surface where the chemical resistance is to be improved.

The glass article according to the invention can be covered by any layer after the treatment of the present invention. The layer can be deposited onto the surface that has been treated according to the invention or onto the surface opposite that which has been treated according to the invention.

The glass article according to the invention has an improved chemical resistance. This should be understood to mean an improved resistance to chemical agents compared to that of known glasses. Chemical agents are understood to be atmospheric agents such as rain water possibly containing pollutants usually found in the atmosphere, in dissolved or suspended state, as well as some, possibly aqueous, synthetic solutions containing alkalising, acidifying and/or oxidation-reduction chemical agents possibly in the presence of various organic or inorganic solvents. The resistance of the article according to the invention is shown by an absence of corrosion or weight loss under prolonged influence of chemical agents for periods that can extend to several years or at least by a significant reduction in this corrosion or weight loss to insignificant values for use of the article.

According to the invention, the glass article contains at least one chemical reinforcing agent. This chemical reinforcing agent is a chemical composition that can enclose completely foreign components in the composition of the bulk of the glass of the article. Conversely, in a variant, it can also contain one or more chemical compounds already present in the composition of the bulk of the glass of the article.

According to the invention, the chemical reinforcing agent is formed from particles that are partially incorporated into the bulk of the glass. Particle partially incorporated into the bulk of the glass is understood to mean a particle that is located both within the bulk of the glass and outside the bulk of the glass. In other words, the particle is not completely surrounded by the glass.

If the glass article has not been covered by any layer prior to the treatment according to the invention, as is the case in FIG. 1, the particles (2) have one part of their volume in the glass (1) and the other part of their volume in the external medium.

A particular embodiment of the invention, in which the glass article has been covered by any layer prior to the treatment according to the invention and on the surface treated according to the invention, is illustrated in FIG. 1. In this case, the particles (3) according to the invention have one part of their volume in the glass (1) and the other part of their volume in the material of said layer (4). Alternatively, the particles (5) according to the invention have one part of their volume in the glass (1) and the other part of their volume is distributed between said layer (4) and the external medium.

Each particle according to the invention is formed from a single chemical compound of the chemical reinforcing agent. In a variant, it can also be formed from a composition of several different chemical reinforcing agents. In this latter case, the composition is not necessarily homogeneous.

According to a preferred feature of the article of the invention, the particles are formed from at least one inorganic compound. According to this feature, each particle is formed by at least one inorganic chemical compound of the chemical reinforcing agent. Any inorganic chemical compound that eliminates or reduces corrosion or weight loss of the glass article can be suitable.

However, it is generally preferred that in the glass article according to the invention the inorganic chemical compound forming the particles is selected from the oxides, nitrides, carbides and combinations of at least two oxides and/or nitrides and/or carbides.

It is further preferred if the inorganic compound is selected from the oxides of magnesium, calcium, strontium, barium or from the oxides, nitrides and carbides of scandium, yttrium, lanthanum, titanium, zirconium, vanadium, niobium, tantalum, aluminium, gallium, indium, silicon, germanium, tin, and the combinations of at least two of the abovementioned compounds.

It is still further preferred if the inorganic compound is selected from the oxides of magnesium, calcium, aluminium, silicon and tin, and the combinations of at least two of these compounds.

Of all these compounds that significantly reinforce the chemical durability of the glass, aluminium oxide and silicon oxide have given the best results. Aluminium(III) oxide (Al₂O₃), when used alone, has proved to be a very interesting chemical reinforcing agent. Moreover, silicon(IV) oxide (SiO₂), when used alone, has also produced a glass effectively reinforced by particles.

According to the invention, in the case where an inorganic chemical compound comprising particles is already present in the composition of the bulk of the glass of the article, it is possible to define a surface enrichment of glass by said compound. The surface enrichment by an inorganic compound already present in the bulk of the glass is expressed as a percentage of the total weight of the glass and is defined as the difference between the percentage by weight of said compound in a zone extending from the surface to a maximum depth of 100 μm in the direction of the core of the glass article and the percentage by weight of said compound in the core of the article.

According to the invention, if the inorganic compound selected is aluminium(III) oxide, for example, the surface enrichment by aluminium oxide is higher than or equal to 0.02% by weight and preferably higher than or equal to 0.05%. Moreover, the surface enrichment by aluminium oxide according to the invention is lower than 20% by weight and preferably lower than 15%.

According to the invention, if the inorganic compound selected is silicon(IV) oxide, for example, the surface enrichment by silicon oxide is higher than 0.02% by weight and preferably higher than 0.05%. Moreover, the surface enrichment by silicon? oxide according to the invention is lower than 25% by weight and preferably lower than 20%.

According to another particular feature of the article of the invention, the particles have a size that is not smaller than 5 nm and preferably not smaller than 50 nm. Moreover, the particles have a size that is not larger than 1500 nm and preferably not larger than 1000 nm. Size should be understood to mean the largest dimension of the particles.

According to another preferred feature of the invention, the particles are at least partially crystallised, i.e. that at least a proportion of 5% of their weight is formed by crystals. The crystals can belong to several different crystallisation systems. In a variant, they can also all be of the same crystallisation system. Preferably at least 50% of the weight of the inclusions is in a crystallised form. It is most particularly preferred if all the particles are in crystallised form.

According to a particular feature of the article of the invention, the shape of the particles is quasi-spherical. Quasi-spherical is understood to mean a three-dimensional shape, the volume of which approaches that of a sphere with a diameter that would be equal to the largest dimension of an object having this quasi-spherical shape. It is preferred if the volume of the particles is equal to at least 60% of that of the sphere having a diameter equal to the largest dimension of the particles. It is more preferred if the volume of the particles is equal to at least 70% of that of the sphere having a diameter equal to the largest dimension of the particles.

In addition to particles (2) partially incorporated into the bulk of the glass (1), the glass article according to the invention can comprise particles (6) that are completely incorporated into the bulk of the glass (1) and to be found below the surface of the glass at a close distance therefrom. This particular embodiment is shown in FIG. 3.

According to another particular embodiment of the article of the invention, which is compatible with all the particular shapes and features described above, the glass article according to the invention can also comprise particles that are deposited onto the surface of the article and adhere thereto.

According to a further particular embodiment of the article of the invention, which is likewise compatible with all the particular shapes and features described above, the glass article can be subjected to a complementary treatment for depleting Na⁺ ions, which enables the sodium and/or potassium content to be eliminated or greatly reduced in a thin zone close to the surface of the glass. The glass article that has undergone a depletion treatment has a sodium content close to the surface of the glass that is lower than the sodium content within the core of the glass article. It is preferred if the depletion treatment is achieved with a known process that consists of treating the surface of the glass using sulphur dioxide, SO₂, which pumps the Na⁺ ions to the surface of the glass forming a layer of sodium sulphate on this same surface.

According to another embodiment of the article of the invention, the glass of the article according to the invention is formed by a sheet of flat glass.

According to this embodiment, the flat glass can be, for example, a float glass, a drawn glass or a patterned glass.

Still according to this embodiment, the flat glass sheet can be subjected to the treatment of the invention on a single face or alternatively on both its faces. In the case of a treatment on a single face of a sheet of patterned glass, the treatment according to the invention is advantageously conducted on the non-patterned face of the sheet if this is patterned on a single face.

The glass article according to the invention is preferably formed from a sheet of soda-lime flat glass.

The article according to the invention can be obtained by any process that is able to generate and partially incorporate particles into the bulk of the glass of said article.

In particular, the invention relates to an article corresponding to the above descriptions that is obtained by a process that includes (a) the production of particles, (b) the deposition of the particles onto the surface of said article, and (c) the supply of energy to the particles and/or to said surface in such a manner that the particles diffuse/are incorporated into the glass.

The formation and deposition of particles on the surface of the glass article can be performed simultaneously in one step using known methods such as:
chemical vapour deposition (or CVD): a modified chemical vapour deposition process (or MCVD) can be used in the present invention. This modified method differs from the classical way in that the precursor reacts in gaseous phase rather than on the surface of the glass.
wet deposition such as sol-gel deposition, for example, or
flame spraying starting from a liquid, gaseous or solid precursor.

In flame spraying, which is cited by way of example and is disclosed in particular in patent application FI954370, the particles are generated by spraying a solution of at least one chemical precursor as an aerosol transported into a flame where combustion occurs to form solid particles. These particles can then be deposited directly onto a surface located close to the edge of the flame. This method in particular has provided good results.

In a variant, the formation and deposition of particles on the surface of the glass articles can be performed consecutively in two steps. In this case, the particles are generated firstly in solid form or in the form of a suspension in a liquid using the vapour method, the wet method (sol-gel, precipitation, hydrothermal synthesis . . . ) or using the dry method (mechanical grinding, mechanical-chemical synthesis . . . ). An example of a method that enables particles to firstly be generated in solid form is the method known as combustion chemical vapour condensation (or CCVC). This method consists of converting a precursor solution in vapour phase in a flame that undergoes a combustion reaction to form particles that are then collected.

The firstly generated particles can then be transferred to the surface of the glass article using different known methods.

The energy necessary for the diffusion/partial incorporation of the particles into the bulk of the glass can be supplied, for example, by heating the glass article to an appropriate temperature.

According to the invention, the necessary energy for the diffusion/partial incorporation of the particles into the bulk of the glass can be supplied at the time of deposition of the particles or after deposition.

The following examples illustrate the invention without intending to restrict its coverage in any way.

### EXAMPLE 1

### According to the Invention

A sheet of clear soda-lime float glass with a thickness of 4 mm and measuring 20 cm×20 cm was washed consecutively in flowing water, deionised water and isopropyl alcohol and then dried.

Hydrogen and oxygen were fed into a linear burner in order to generate a flame at the outlet of said burner. The burner used had a width of 20 cm and had five nozzles for supply of the solution. The washed glass sheet was heated firstly in a furnace to a temperature of 770° C. and at this temperature was then passed under the burner located at a distance of 150 mm above the glass sheet at a speed of about 4 m/min. The solution fed into the flame by means of the nozzles contained nonahydrate aluminium nitrate, Al(NO₃)₃.9H₂O, dissolved in methanol (aluminium/methanol dilution ratio by weight=1/22, solution flux=100 ml/min). Particles of aluminium oxide were thus generated in the flame and collected on the surface of the glass sheet. The glass sheet was then cooled in the ambient air.

The glass sheet treated as described above was analysed by scanning and transmission electron microscopy, by atomic force microscopy, by X-ray fluorescence spectrometry, by X-ray photoelectron spectroscopy, by secondary ion mass spectrometry and by electron diffraction.

The analyses performed demonstrated that the aluminium was incorporated in the form of aluminium oxide particles partially incorporated into the bulk of the glass. The particles were quasi-spherical in shape and had a size varying from 200 to 1000 nm. The particles were predominantly crystalline. The surface enrichment through aluminium oxide was 0.9% by weight.

FIG. 4 shows an image obtained by transmission electron microscopy of a section of the treated glass sheet. It shows an aluminium oxide particle partially incorporated into the bulk of the glass. The glass is located in the upper section of the image, while the external medium is located in the lower section. This particle is quasi-spherical and has a size of about 250 nm.

Climate chamber analyses that allow accelerated ageing of the treated glass sheet were conducted to show the effect of the partial incorporation of aluminium oxide particles on the chemical resistance of the glass. A comparison was made with an identical but untreated glass sheet (reference).

In the climate chamber the treated glass sheet and the reference sheet were exposed to temperature cycles between 45° C. and 55° C. in a constant relative humidity of 98% for up to 22 days. The duration of one cycle was exactly 1 hour 50 minutes and 12 cycles were made per day. Once a day the temperature was reduced from 45° C. to 25° C. in 30 minutes and was maintained at 25° C. for one hour. The temperature was then increased once again from 25° C. to 45° C. in 30 minutes and a temperature cycle was started again. The glass sheets were examined after precise periods of time.

After 2 days in the climate chamber the reference untreated glass sheet showed signs of corrosion. The glass sheet treated using the method described above only showed signs of corrosion after 22 days in the climate chamber. The presence of aluminium oxide particles partially incorporated into the bulk of the glass thus allows a glass to be produced that has an improved chemical resistance.

### EXAMPLE 2

### According to the Invention

A glass article according to the invention was produced in a plant for the continuous production of soda-lime flat patterned glass. This plant comprises a melting furnace, a rolling machine and a lehr. The glass in melted state flowed in ribbon form from the melting furnace into the rolling machine where it was passed between two superposed rollers, one of which is smooth and the other engraved with a printed pattern. This printed pattern was then reproduced on a single face of the glass: that directed downwards of the horizontal ribbon. After passing through the rolling machine the glass ribbon had an average thickness of 4 mm (3.5-4.5 mm). It was then passed towards a 2 m wide linear burner at a constant speed of about 3.9 m/min and at a temperature of 725° C.

The burner was supplied with hydrogen and oxygen in order to generate a flame at the outlet of said burner and was located at a distance of 120 mm above the non-patterned side of the glass sheet. A solution containing nonahydrate aluminium nitrate, Al(NO₃)₃.9H₂O, dissolved in methanol (aluminium/methanol dilution ratio by weight=1/20, flux=1000 ml/min) was fed into the flame. Aluminium oxide particles were thus generated in this flame and collected on the surface of the glass sheet.

The glass sheet was lastly passed towards the lehr where it was cooled in a controlled manner in the conditions usually used for patterned flat glass.

The glass sheet treated as described above was analysed using the same techniques are those mentioned in Example 1.

The conducted analyses showed that the aluminium was incorporated in the form of aluminium oxide particles partially incorporated into the bulk of the glass. The particles were quasi-spherical in shape and had a size varying from 170 to 850 nm. The particles were also predominantly crystalline. The surface enrichment through aluminium oxide was 0.6% by weight.

FIG. 5 shows an image obtained by transmission electron microscopy of a section of the treated glass sheet. It shows an aluminium oxide particle partially incorporated into the bulk of the glass. The glass is located in the upper section of the image, while the external medium is located in the lower section. This particle is quasi-spherical and has a size of about 430 nm.

Furthermore, the glass sheet treated as described above also comprises particles that are completely incorporated into the bulk of the glass and have a size that also varies from 200 to 670 nm. These particles are also predominantly crystalline.

Climate chamber analyses were also conducted in the same conditions as those used in Example 1.

After 2 days in the climate chamber the reference untreated glass sheet showed signs of corrosion. The glass sheet treated using the method described above only showed signs of corrosion after 10 days in the climate chamber.

### EXAMPLE 3

### According to the Invention

A sheet of clear soda-lime float glass with a thickness of 4 mm and measuring 20 cm×20 cm was washed consecutively in flowing water, deionised water and isopropyl alcohol and then dried.

The washed glass sheet was heated firstly in a furnace to a temperature of 1000° C. and at this temperature was then passed at a speed of about 4 m/min under a flow of air heated to 1000° C. (flow rate=60 Nm³/h), into which nanoparticles of aluminium oxide such as those supplied by PlasmaChem were injected. The particles that were used had a size varying from 5 to 150 nm and were predominantly crystallised. The glass sheet was then cooled in the ambient air.

The glass sheet treated as described above was analysed using the same techniques are those mentioned in Example 1.

The analyses showed that aluminium oxide particles were partially incorporated into the bulk of the glass and the results obtained with respect to size and crystallinity are consistent with the starting characteristics of the particles injected into the air flow. The treated glass sheet also comprised particles that were completely incorporated into the bulk of the glass. The surface enrichment through aluminium oxide was 2.5% by weight.

1. A glass article, comprising particles partially incorporated into the bulk of the glass, wherein the particles comprise at least one chemical reinforcing agent.

2. The article of claim 1, wherein the particles are at least partially crystallized.

3. The article of claim 2, wherein the particles are completely crystallized.

4. The article of claim 1, wherein the particles are formed from at least one inorganic compound.

5. The article of claim 4, wherein the inorganic compound is at least one selected from the group consisting of an oxide, a nitride, and a carbide.

6. The article of claim 4, wherein the inorganic compound is at least one oxide selected from the group consisting of oxides of magnesium, calcium, strontium, barium, scandium, yttrium, lanthanum, titanium, zirconium, vanadium, niobium, tantalum, aluminium, gallium, indium, silicon, germanium, and tin.

7. The article of claim 4, wherein the inorganic compound is at least one oxide selected from the group consisting of oxides of magnesium, calcium, aluminium, silicon, and tin.

8. The article of claim 4, wherein the inorganic compound is an aluminium(III) oxide.

9. The article of claim 8, having a surface enrichment by aluminium(III) oxide higher than or equal to 0.02% by weight and lower than or equal to 20% by weight.

10. The article of claim 7, wherein the inorganic compound is a silicon(IV) oxide.

11. The article of claim 1, wherein the particles are quasi-spherical in shape.

12. The article of claim 1, wherein the particles have a size in a range of between 5 and 1500 nm.

13. The article of claim 1, having a sodium content at a surface of the glass that is lower than a sodium content within a core of the article.

14. The article of claim 1 produced by a process, in which the particles are generated in a flame starting from at least one precursor.

15. The article of claim 1 formed from a sheet of soda-lime flat glass.

16. The article of claim 4, wherein the inorganic compound is at least two selected from the group consisting of an oxide, a nitride, and a carbide.

17. The article of claim 4, wherein the inorganic compound is at least two oxides selected from the group consisting of oxides of magnesium, calcium, strontium, barium, scandium, yttrium, lanthanum, titanium, zirconium, vanadium, niobium, tantalum, aluminium, gallium, indium, silicon, germanium, and tin.

18. The article of claim 4, wherein the inorganic compound is at least two oxides selected from the group consisting of oxides of magnesium, calcium, aluminium, silicon, and tin.

19. The article of claim 4, wherein the inorganic compound comprises an aluminium(III) oxide.

20. The article of claim 7, wherein the inorganic compound comprises a silicon(IV) oxide.
